(19) United States
(12) Patent Application Publication
(10) Pub. No.: US 2015/0120398 A1
(43) Pub. Date: Apr. 30, 2015

(54) SYSTEMS AND METHODS FOR EVALUATING INTERVIEWERS

(71) Applicant: Linkedln Corporation, Mountain View, CA (US)

(72) Inventors: Michael Olivier, Belmont, CA (US); Evan Brynne, Mountian View, CA (US); Benjamin Hoan Le, San Jose, CA (US); Christina Amanda Wong, Fremont, CA (US)

(73) Assignee: Linkedln Corporation, Mountain View, CA (US)

(21) Appl. No.: 14/069,150

(22) Filed: Oct. 31, 2013

(51) Int. Cl. G06Q 10/06

(52) U.S. Cl. CPC G06Q 10/06398
USPC 705/7.42

(57) ABSTRACT

A system calculates an overall talent scout score for each of a plurality of interviewers, ranks the plurality of interviewers as a function of the overall talent scout score for each of the plurality of interviewers, and displays on a computer display device a representation of the overall talent scout scores for each of the plurality of interviewers. In another embodiment, the system calculates a participation score for each of the plurality of interviewers, ranks the plurality of interviewers as a function of the overall talent scout score for each of the plurality of interviewers and the participation score for each of the plurality of interviewers, and displays on a computer display device a representation of the overall talent scout scores and the participation scores for each of the plurality of interviewers.

### TECHNICAL FIELD

The present disclosure generally relates to data processing systems. Specifically, the present disclosure relates to methods, systems and computer storage devices for providing a system and method to evaluate the effectiveness of interviewers of job candidates.

### BACKGROUND

Many business organizations today, especially large corporations, struggle with the interviewing and hiring of job candidates. The interviewing and hiring processes are difficult, time consuming, non-automated, and many times do not result in the hiring of a candidate who will be a productive employee. As many a business manager or human resources person knows, a bad hire can be a real headache.

### DESCRIPTION OF THE DRAWINGS

Some embodiments are illustrated by way of example and not limitation in the FIG's. of the accompanying drawings, in which:

FIG. 1 is an example display of a ranking of a plurality of interviewers;

FIG. 2 is an example display of an interface, information, and links for a particular interviewer from the display of FIG. 1;

FIG. 3 is an example display of statistics for a particular interviewer;

FIG. 4 is an example display of an interface, information, and links of delegation options of a particular interviewer;

FIG. 5 is another example display of an interface, information, and links of delegation options of a particular interviewer;

FIG. 6 is an example interface illustrating information relating to a job offer to a candidate;

FIG. 7 is an example of a user interface and display explaining the interpretation of the displayed ranking of interviewers of FIG. 1;

FIGS. 8A, 8B, and 8C are a flowchart of an example process of ranking a plurality of interviewers; and

FIG. 9 is a block diagram of an example embodiment of a computer system upon which an embodiment of the current disclosure can execute.

### DETAILED DESCRIPTION

The present disclosure describes methods, systems, and computer storage devices for evaluating interviewers of job candidates. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

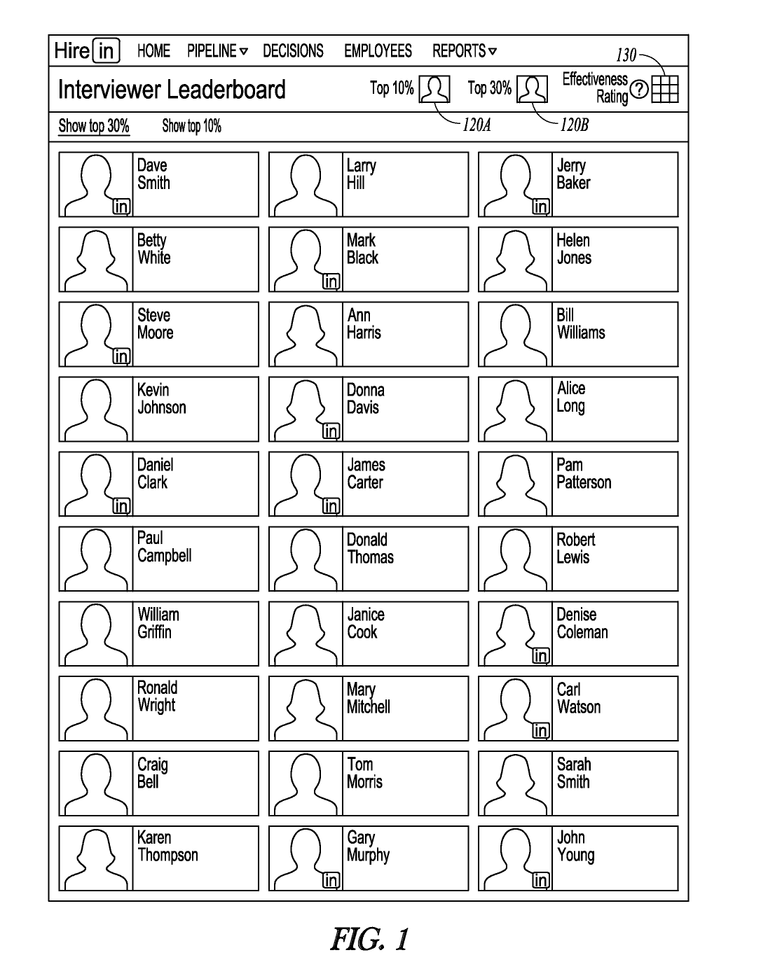

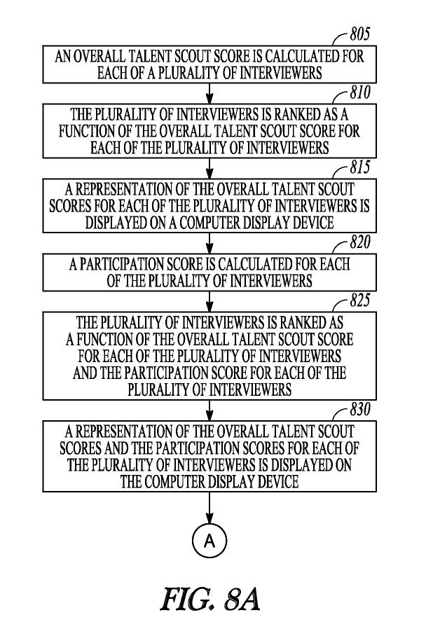

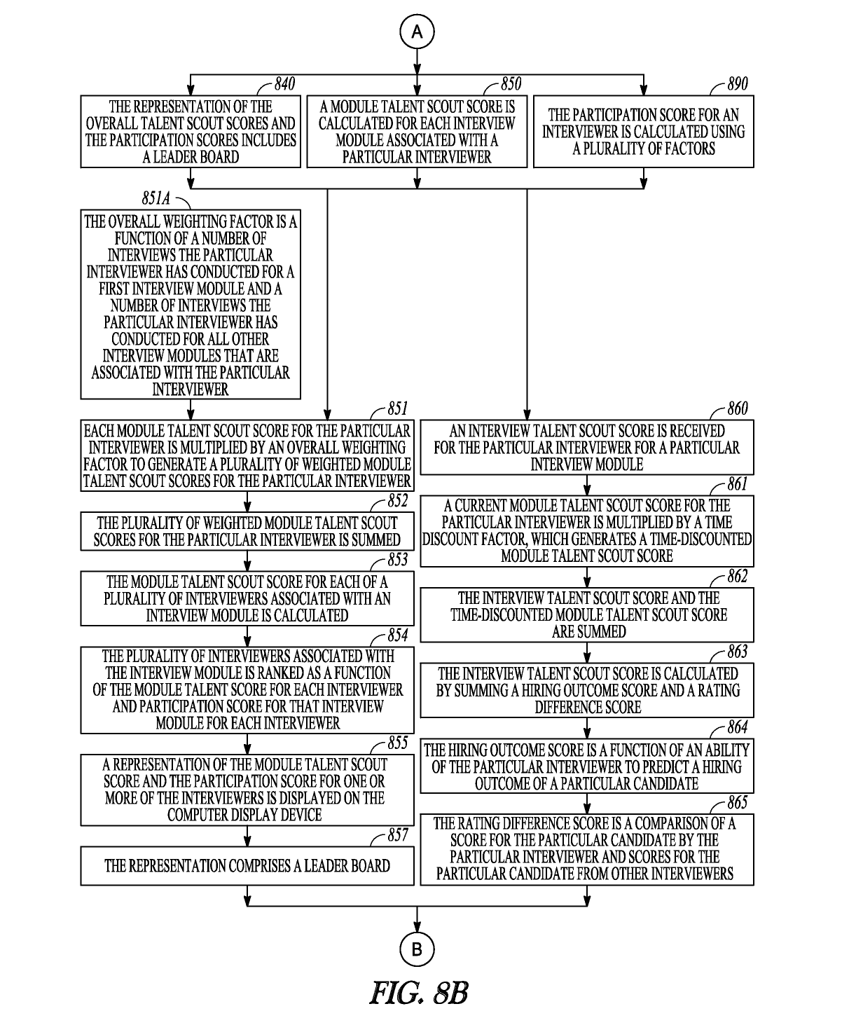

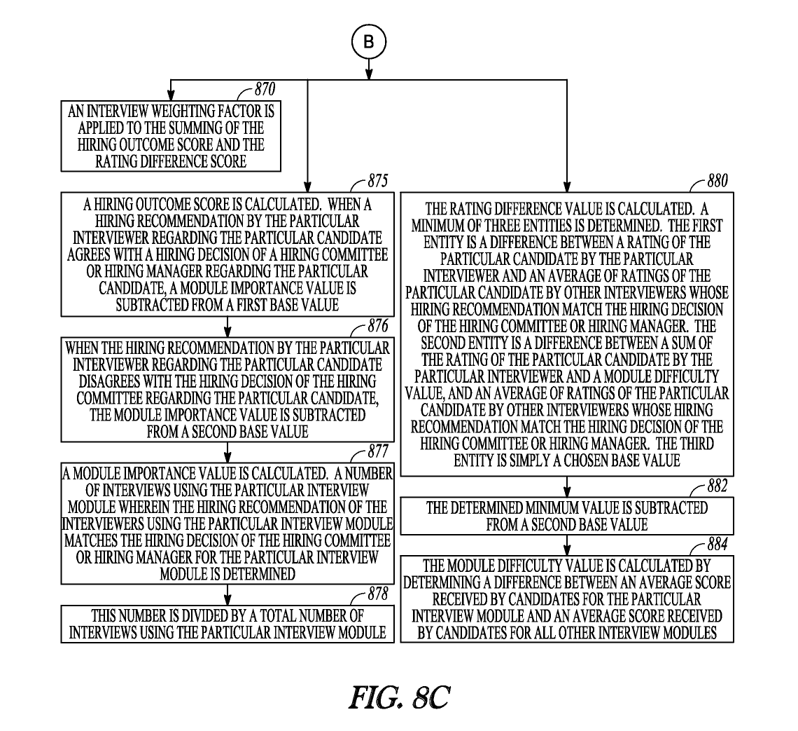

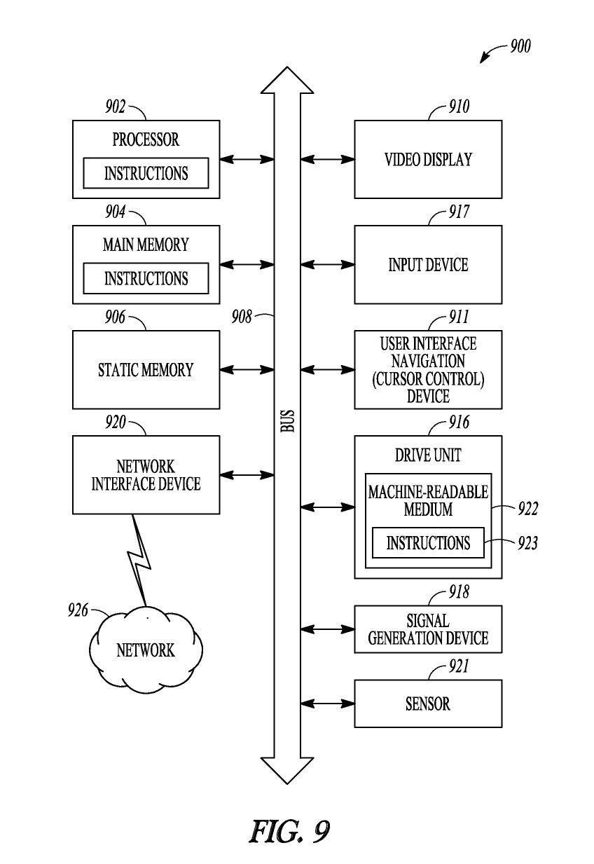

In a general embodiment, a system and process to evaluate and rate an interviewer of job candidates involves rating an interviewer for each of several interview modules, aggregating the ratings for each of the interview modules for a particular interviewer, determining a participation level of the particular job interviewer for interviews assigned to the particular interviewer, and comparing the particular job interviewer to several other interviewers in the business organization. As disclosed herein, the system and process include intelligence and user interfaces. The system and process are illustrated in FIGS. 1-9. FIGS. 1-7 illustrate many of the user interfaces, and FIGS. 8-9 illustrate flow charts and other diagrams relating to the evaluation and ranking of interviewers for job candidates.

Several of the figures include a number of process blocks. Though generally arranged serially in the figures, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations. With some embodiments, some of the method operations illustrated in the figures may be performed offline by means of a batch process that is performed periodically (e.g., two times a day, daily, weekly, and so forth), while in other embodiments, the method operations may be performed online and in real-time as requests for interviewers and interview schedules are being received and processed.

In an embodiment, a system and method rank personnel of a business organization who conduct interviews of job candidates by the interviewers' ability to access the talent and probable success and effectiveness of the job candidates. The system evaluates and reports how each interviewer measures up against other interviewers. The system provides an assessment of top interviewers and interviewers who may need a bit more training and experience in screening the talent of job candidates during job interviews.

The system generates an overall talent scout score and one or more interview module talent scout scores for each of a multitude of interviewers. An interview module talent scout score is calculated for each interview module for which the interviewer has given an interview. An interview module is a vehicle used in a job interview to assess a job candidate. The interview module relates to a particular subject matter, and can include example questions and follow up questions. These questions can be verbal-based questions or technical-based problem solving questions. In general, the overall talent scout score is determined by aggregating all of the interview module talent scout scores for a particular interviewer.

The evaluation of an interviewer, and the ranking of and comparison of an interviewer to other interviewers in the business organization, is made available to the interviewers and others in a display format on a computer output display unit. In an embodiment, the output is displayed on an interviewer leader board. An example of an interviewer leader board is illustrated in FIG. 1, and will be discussed in more detail herein. In an embodiment, such an interviewer leader board takes into account an interviewer's overall talent scout score and a participation score for the interviewer. Interviewers are ranked by the sum of their percentile standings in terms of overall talent scout score and their participation score. In another embodiment, interviewers are ranked simply by their talent scout score without regard to their participation score.

As noted, the evaluations and rankings of the interviewers are displayed on a computer display unit. The interviewers, management, and others in the business organization can view the display of the output and rankings. The display permits the persons to view the relative talent score standings as compared to all interviewers both from an overall standpoint and on an interview module basis (that is, each interview module for which the interviewer has participated in an interview of a job candidate). The relative rank of an interviewer's interview module talent scout score is displayed on the computer display device to aid in the assessment and identification of the interview modules in which a particular interviewer does well and the interview modules for which the interviewer may need a bit more experience and/or training.

In an embodiment, overall talent scout scores are calculated periodically as a weighted average over the plurality of an interviewer's interview module talent score scores. Each interview module talent scout score is weighted by the frequency that an interviewer participates in that particular interview module as compared to the interviewer's participation in other interview modules. Interview modules that an interviewer gives interviews for more often will have a greater impact on that interviewer's overall talent scout score. Consequently, for an individual interviewer:

Overall talent scout score=module talent scout score*interview frequency for that module (over all of the interviewer's interview modules)

As explained in detail herein, the interview module talent scout score is calculated as a time-discounted sum of the interviewer's interview talent scout scores. Interview module talent scout scores are discounted by time so that more recent interviews have a higher impact on an interviewer's module/overall talent scout scores than interviews that occurred farther in the past. When a new interview module talent scout score (for a particular interview module) is generated for an interviewer, the interviewer's corresponding interview module talent scout score (that is, the interview module talent scout score of the module for which the interviewer gave the interview) is updated.

In an embodiment, the time factor used to time discount the interview module talent scout score is 0.935. With a time discount factor of 0.935, the half life of a particular interview module talent scout score is reached after approximately ten (10) more interview module talent scout scores are recorded. This time factor can be modified of course to either increase or decrease the number of interviews needed to reach the half life of a particular interview module talent scout score. An interviewer's interview module talent scout score for any given interview module can then be calculated as follows:

Interview module talent scout score=interview module talent scout score+(time discount factor*interview module talent scout score)

The above-mentioned interview talent scout score is calculated for each interview in which an interviewer participates, and it represents how well the interviewer did in assessing the particular job candidate in the interview. In an embodiment, the interview is scored when the interview was an on site interview (as contrasted with an initial over the telephone or web-based interview). The interview talent scout score is calculated as a weighted sum of two factors—a hiring outcome score and a rating difference score. The hiring outcome score indicates how well the interviewer predicted the eventual hiring outcome of the job candidate that the interviewer interviewed. The rating difference score indicates the deviation of the interviewer's score for that particular job candidate from the scores of other interviewers for that particular job candidate.

Specifically, in an embodiment, for the hiring outcome score, the interviewer is given a base score of either 1 or 0, depending on whether the interviewer's rating of the job candidate matched the eventual hiring outcome of the job candidate. In this embodiment, a rating of 3.0 (of the job candidate by the interviewer) or above is considered a match for an eventual decision to hire the candidate, whereas a rating of below 3.0 is considered a match for an eventual decision not to offer a job position to the job candidate. In many business organizations, hiring decisions are made by a hiring committee or hiring manager, wherein the hiring committee and/or hiring manager decide whether or not to extend a job offer to a particular candidate.

An interview module importance value, which is explained in detail herein, for the interview module for which the interviewer gave the interview is subtracted from the base (as indicated in the previous paragraph, in an embodiment, either 1 or 0). This operation indicates a correlation (or a lack of correlation) between the particular interview module and the decision of the hiring committee or hiring manager. For example, if a particular interview module is deemed to be very important in the decision making process of the hiring committee or hiring manager, an interviewer giving an interview for that particular interview module is given less credit for agreeing with the hiring decision of the hiring committee or hiring manager. That is, the hiring committee or hiring manager defaults to the hiring decision of the hiring committee or hiring manager. However, if the interviewer's score for the job candidate did not match the decision of the hiring committee or hiring manager, the interviewer should not be rewarded or given credit, since the interviewer's rating disagreed with the hiring decision of the hiring committee or hiring manager. In summary, the hiring outcome score is calculated in the following two ways:

Hiring outcome score=1−Interview Module Importance (if interviewer and hiring committee or hiring manager agree)

Hiring outcome score=0−Interview Module Importance (if interviewer and hiring committee or hiring manager disagree)

The rating difference score is calculated as follows:

Rating Difference Score=0.5−min(abs(Interviewer's Rating−Average Rating Of Interviewers Who Matched Hiring Committee or Hiring Manager),abs((Interviewer's Rating+Module Difficulty)−Average Rating Of Interviewers Who Matched Hiring Committee or Hiring Manager),1.0).

In the above equation, the interviewer's rating is the rating given to the job candidate by the interviewer (1.0-4.0). The average rating of interviewers who matched the decision of the hiring committee or hiring manager is the unweighted mean value of all interview ratings that matched the decision of the hiring committee or hiring manager for this particular job candidate. (e.g., if the hiring committee or hiring manager votes to hire, only ratings of >=3.0 are considered). The module difficulty in the above equation is the difficulty of the interview module for which the interviewer gave the interview.

More specifically, the module difficulty is a value representing how difficult that interview module is for candidates, as compared to other interview modules. The interview module difficulty is defined by the average rating job candidates receive for that module. A low difficulty score means that interviewers tend to give very high ratings in this interview module as compared to other interview modules. A high difficulty score means ratings given in this interview module tend to be low. In an embodiment, to calculate a module's difficulty, an average (i.e. an unweighted mean) rating is determined and given for each module from the pool of eligible interviews. Once the average rating for each module is determined (Rm for each module m), another average over these values is calculated to get the average of the average module rating (A). The difference of a given Rm from A is the difficulty of module m. Consequently,

### Rm=The Average Rating Given to Candidates in Module m

A=The Average Rm Value Over All Modules. Then the difficulty for a module m is calculated as follows:

Module Difficulty=A−Rm

A key point is that the value of (Interviewer's Rating+Module Difficulty) can be considered the interviewer's “Adjusted Rating”, based on how difficult the interviewer's interview module is in comparison to other interview modules. If an interview module is very difficult or very easy, the rating that the interviewer gave in the interview using this interview module can be adjusted to ensure that the interviewer is not penalized for accurate ratings that deviate from ratings given by other interviewers because candidates tend to do either poorly or do well in that interview module. The minimum of the two absolute differences (between an Interviewer's Rating and Average Rating Of Interviewers Who Matched Hiring Committee and between an Adjusted Rating and an Average Rating Of Interviewers Who Matched Hiring Committee) is taken such that adjusting an interviewer's ratings based on module difficulty will not negatively impact the interviewer's score. In an embodiment, the maximum difference is 1.0 such that the lowest score a person can achieve in this category is −0.5. This minimum value is subtracted from a base score of 0.5, which means that any rating (or adjusted rating) within 0.5 of the average rating of candidate results in a net positive score.

The module importance is a value, in an embodiment, from 0 to 1 representing how much sway that particular interview module has over the hiring committee's or hiring manager's decision of whether or not to make a job offer to the job candidate, as measured relative to other interview modules. An interview module having a high module importance value means that hiring recommendations given in this interview module tend to be more consistent with the hiring committee's decisions of whether or not to extend a job offer to a job candidate. An interview module having a low importance value means that hiring recommendations given in this interview module tend to be less consistent with the hiring committee's or hiring manager's decisions on whether or not to extend a job offer. The importance of an interview module is determined by calculating the proportion of interviews in that interview module where the interviewer's recommendation for that job candidate matches the hiring committee's or hiring manager's final decision of whether or not to extend a job offer. In an embodiment, an interviewer will recommend the hiring of a job candidate whenever the interviewer gives a rating of 3.0 or higher for that job candidate, and will recommend the rejection of a candidate whenever the interviewer gives a rating less than 3.0. In summary, the interview module importance can be determined as follows:

Module Importance=(# of Interviews where Interview Recommendation==Hiring Committee's Decision)/(Total # of Interviews in that Module)

In an embodiment, weights are assigned to the Hiring Outcome Score and the rating difference score. In a further embodiment, these weights are equal to 1.0 for the hiring outcome score and 0.5 for the rating difference score. Ultimately, being consistent with the decisions of the hiring committee or hiring manager on a job candidate is the most indicative factor in being considered a good assessor of talent. Thus, the weight given to the Hiring Outcome Score is greater than the weight applied to rating difference score when determining interview talent scout scores.

Then, to put everything together and arrive at an interview talent scout score, the following is determined:

Interview Talent Scout Score=Hiring Outcome Score Weight*Hiring Outcome Score+Rating Difference Score Weight*Rating Difference Score.

In an embodiment the overall talent scout scores for a plurality of interviewers can be normalized in such a manner that each interviewer's overall talent scout score would fall into a particular fixed bucket or range. In this manner, more than one interviewer can have the same rating, and in particular, more than one interviewer can have the overall “top” rating. For example, a top range of overall talent scout scores can be defined, and each interviewer who overall talent scout score falls into that range could receive a top rating. In this manner, for example, more than one interviewer can have a rating or grade of A+ (even though each individual who receives an A+ may not have the same overall talent scout score).

FIGS. 8A, 8B, and 8C are a flowchart of an example process 800 for ranking interviewers. FIGS. 8A, 8B, and 8C include a number of process blocks 805-890. Though arranged serially in the example of FIGS. 8A, 8B, and 8C, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 8A, at 805, an overall talent scout score is calculated for each of a plurality of interviewers. At 810, the plurality of interviewers is ranked as a function of the overall talent scout score for each of the plurality of interviewers. At 815, a representation of the overall talent scout scores for each of the plurality of interviewers is displayed on a computer display device. In an embodiment, at 820, a participation score is calculated for each of the plurality of interviewers. At 825, the plurality of interviewers is ranked as a function of the overall talent scout score for each of the plurality of interviewers and the participation score for each of the plurality of interviewers. At 830, a representation of the overall talent scout scores and the participation scores for each of the plurality of interviewers is displayed on the computer display device.

Referring now to FIGS. 8B and 8C, at 840, it is noted that the representation of the overall talent scout scores and the participation scores can include a leader board. As illustrated in FIG. 1, a leader board 100 can be represented as a two-dimensional grid. The two dimensional grid can include a plurality of compartments 110. Each compartment 110 relates to a particular composite performance level (e.g., a talent scout score and a participation score). In an embodiment, interviewers having a high overall talent scout score and a high participation score are placed in a compartment 110 in an upper-right portion of the grid, and interviewers having a low overall talent scout score and a low participation score are placed in a compartment 110 in a lower-left portion of the grid.

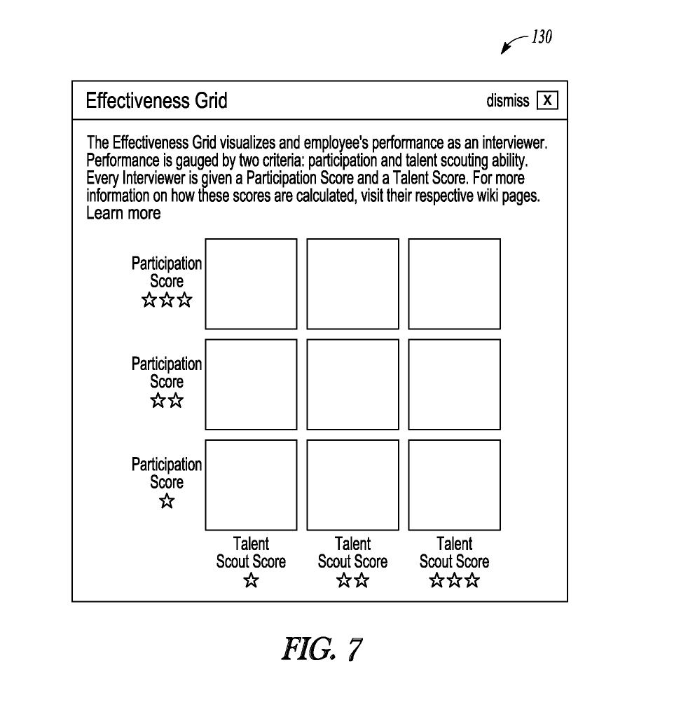

FIG. 1 further illustrates buttons 120A and 120B wherein a user can request that the top 10% or top 30% of the interviewers be displayed respectively. The system can be programmed to display other top percentages also. Clicking on the effectiveness grid icon 130 in FIG. 1 will result in the display of the grid 130 as illustrated in FIG. 7, which explains to the user how the grid 130 can be used to gauge the effectiveness of an interviewer.

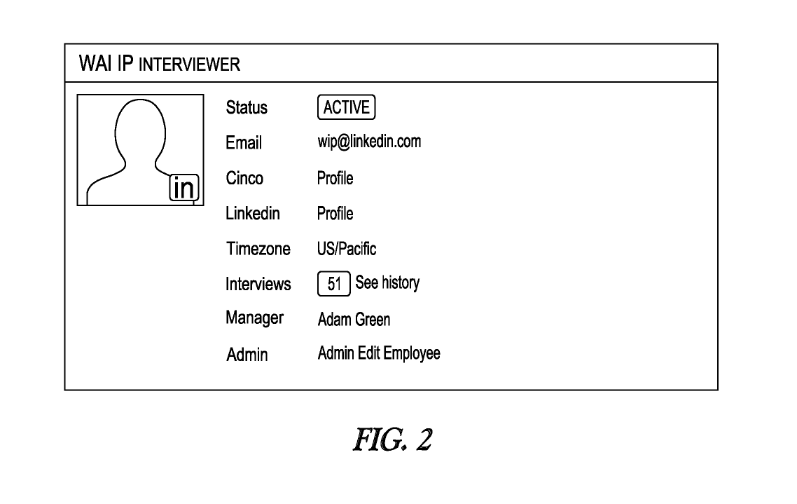

FIG. 2 illustrates an interface that displays information about a particular interviewer such as whether the interviewer is currently actively involved in conducting interviews (as compared to taking a sabbatical from participating in interviews), the interviewer's email address, a link to a profile of the interviewer, the time zone in which the interviewer is based, the number of interviews conducted by the interviewer and a link to an interview history, the manager of the interviewer, and a link to an admin page relating to the interviewer.

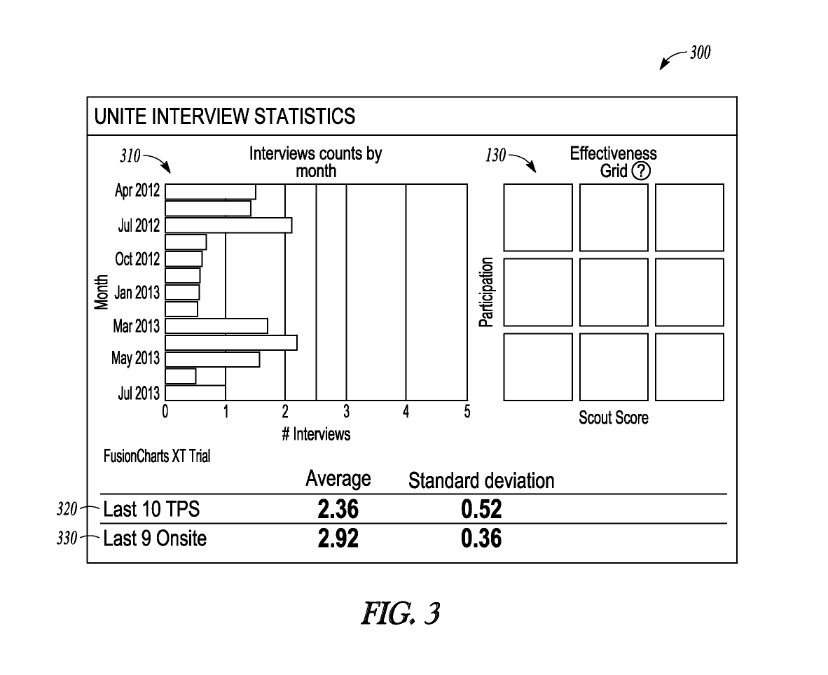

FIG. 3 illustrates an interface 300 of interview statistics that are displayed when the interview history button of FIG. 2 is selected. The interface 300 illustrates interview counts 310 for the interviewer on a per month basis. The interface 300 further illustrates the average rating that the particular interviewer has given to job candidates in telephone interviews 320 and in person interviews 330. The display of the effectiveness grid 130 on the interview history interface 300 indicates how the particular interviewer ranks as compared to the plurality of other interviewers. As illustrated at 340 in FIG. 3, this particular interviewer ranks in the middle for talent scout score but ranks in the upper ranks for the participation aspect of the rating.

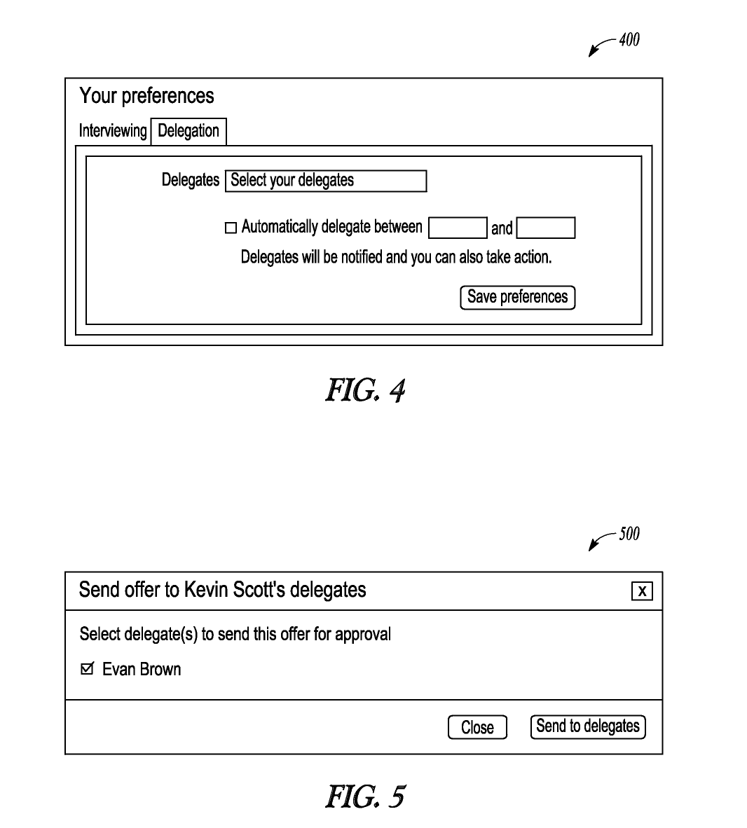

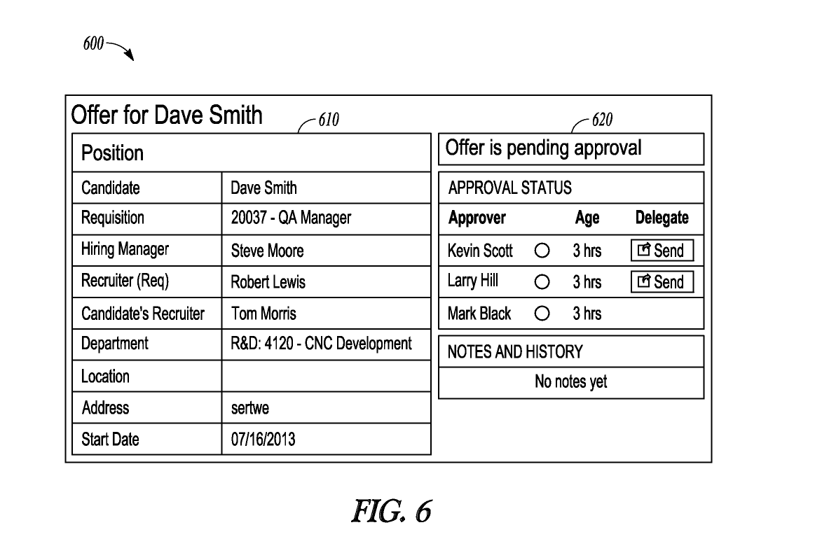

FIG. 4 illustrates a preference interface 400 where an interviewer can select one or more delegates. A delegate can approve an offer to a particular job candidate. These one or more delegates can be selected for a particular time period, as indicated at 410. FIG. 5 illustrates a preference interface 500 where an interviewer can select a particular delegate. FIG. 6 illustrates a user interface 600 that details an offer for a job candidate. The window 610 reports such things as the candidate, an identification of the pertinent requisition, the hiring manager, the recruiters, the department, the location, and the start date. The window 620 illustrates whether or not an approval is pending, and the time or age of the pending approval.

Referring back to FIG. 8B, at 850, a module talent scout score is calculated for each interview module associated with a particular interviewer. At 851, each module talent scout score for the particular interviewer is multiplied by an overall weighting factor to generate a plurality of weighted module talent scout scores for the particular interviewer. As indicated at 851A, the overall weighting factor is a function of a number of interviews the particular interviewer has conducted for a first interview module and a number of interviews the particular interviewer has conducted for all other interview modules that are associated with the particular interviewer. At 852, the plurality of weighted module talent scout scores for the particular interviewer is summed.

At 853, the module talent scout score for each of a plurality of interviewers associated with an interview module is calculated. At 854, the plurality of interviewers associated with the interview module is ranked as a function of the module talent score for each interviewer and participation score for that interview module for each interviewer. At 855, a representation of the module talent scout score and the participation score for one or more of the interviewers is displayed on the computer display device. At 857, the representation comprises a leader board. As noted above, the leader board can be a two-dimensional grid. The two-dimensional grid includes a plurality of compartments, and each compartment relates to a particular composite performance level. The interviewers having a high module talent scout score and a high participation score are placed in a compartment in an upper-right portion of the grid, and interviewers having a low module talent scout score and a low participation score are placed in a compartment in a lower-left portion of the grid.

The calculation of the module talent scout score is illustrated beginning in block 860. At 860, an interview talent scout score is received for the particular interviewer for a particular interview module. At 861, a current module talent scout score for the particular interviewer is multiplied by a time discount factor, which generates a time-discounted module talent scout score. At 862, the interview talent scout score and the time-discounted module talent scout score are summed.

At 863, the interview talent scout score is calculated by summing a hiring outcome score and a rating difference score. At 864, it is noted that the hiring outcome score is a function of an ability of the particular interviewer to predict a hiring outcome of a particular candidate, and at 865, it is noted that the rating difference score is a comparison of a score for the particular candidate by the particular interviewer and scores for the particular candidate from other interviewers.

At 870, an interview weighting factor is applied to the summing of the hiring outcome score and the rating difference score.

The calculation of the hiring outcome score is illustrated beginning at block 875. Specifically, at 875, when a hiring recommendation by the particular interviewer regarding the particular candidate agrees with a hiring decision of a hiring committee or hiring manager regarding the particular candidate, a module importance value is subtracted from a first base value. In an embodiment, the first base value can be a value of 1. At 876, when the hiring recommendation by the particular interviewer regarding the particular candidate disagrees with the hiring decision of the hiring committee regarding the particular candidate, the module importance value is subtracted from a second base value. In an embodiment, the second base value can be a value of 0. Blocks 877 and 878 illustrate the calculation of the module importance value. At 877, a number of interviews using the particular interview module wherein the hiring recommendation of the interviewers using the particular interview module matches the hiring decision of the hiring committee or hiring manager for the particular interview module is determined. Then, at 878, this number is divided by a total number of interviews using the particular interview module.

The calculation of the rating difference score is illustrated beginning at block 880. At 880, a minimum of three entities is determined. The first entity is a difference between a rating of the particular candidate by the particular interviewer and an average of ratings of the particular candidate by other interviewers whose hiring recommendation matches the hiring decision of the hiring committee or hiring manager. The second entity is a difference between a sum of the rating of the particular candidate by the particular interviewer and a module difficulty value, and an average of ratings of the particular candidate by other interviewers whose hiring recommendation matches the hiring decision of the hiring committee or hiring manager. The third entity is simply a chosen base value. In an embodiment, the base value is a value of 1. After determining the minimum of the three entities at 880, then at 882, the determined minimum value is subtracted from a second base value. In an embodiment, the second base value is a value of 0.5. As indicated at 884, the module difficulty value is calculated by determining a difference between an average score received by candidates for the particular interview module and an average score received by candidates for all other interview modules.

As illustrated at 890, a participation score for an interviewer is calculated using a plurality of factors, and in an embodiment, the four criteria indicated below. The interview ranking system ranks all employees who are registered as interviewers by their contribution to the company's interviewing process. The participation metric can be used in several manners, including providing a means that managers can assess top performing interviewers and can also assess interviewers who may need a bit of a push to get more involved.

In an embodiment, the participation algorithm is based on four criteria. The first criterion is the number of interviews “I” that an interviewer has conducted. The second criterion is the percentage “M” of scheduled interviews that have been missed by an interviewer. The system can determine when an interviewer has missed an interview by directly receiving an indication from the interviewer that he or she did not attend the interview, or by determining that the interviewer entered no input data or results pertaining to the interview. The third criterion is the number of modules “Sk” for which the interviewer is qualified as a master interviewer or an apprentice interviewer. The fourth criterion is the average of the ratings “Sc” given by the hiring committee or hiring manager as a review of the feedback on the job candidate that was entered by the interviewer.

The interviewer participation score is the sum of the number of standard deviations that an interviewer is from the mean in the four criteria I, M, Sk, and Sc. Each number of standard deviations is multiplied by a weighting factor. The weighting factor is selected according to how much the employer, hiring committee, or hiring manager values the particular attribute in an interviewer. For example, it can be decided that for one or more reasons, the number of interviews conducted by an interviewer is more important than the number of interviews that an interviewer has missed, and the number of interviews conducted can therefore be weighed more heavily. In a situation wherein an interviewer has no hiring committee ratings for the interviewer's feedback, it is not counted against them, and that interviewer's rating is considered to be at the mean. In an embodiment, persons who are relatively new interviewers in the company, for example those interviewers who have been interviewing three months or less, are also granted an exception. For such new interviewers, their number of interviews per month is calculated using the period for which they have been interviewers, rather than the full time period (that is, in this example, the three month time period).

The mean and standard deviation functions are also used in the calculation of an interviewer's participation score. Specifically, the mean is the average of the criteria (I, M, Sk, Sc) as denoted above across all interviewers, and the standard deviation is simply the standard deviation of the criteria as denoted above across all interviewers.

In an embodiment, an interviewer's participation score can be calculated as follows:

Interviewer Score=((I−mean(I))/std(I))*WF1)+((M−mean(M))/std(M))*WF2)+((Sk−mean(Sk))/std(Sk))*WF3)+((Sc−mean(Sc))/std(Sc))*WF4).

In an embodiment, WF1, WF2, WF3, and WF4 are the above-mentioned weighting factors. In an embodiment, WF1 is equal to 0.1, WF2 is equal to −0.35, WF3 is equal to 0.2, and WF4 is equal to 0.35. Consequently, in this embodiment, an interviewer is penalized quite a bit for missing interviews, as indicated by the −0.35 weighting factor, but is also rewarded a bit for receiving high ratings from the hiring committee or hiring manager for the interviewer's feedback on the job candidate that was entered by the interviewer.

FIG. 9 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 901 and a static memory 906, which communicate with each other via a bus 908. The computer system 900 may further include a display unit 910, an alphanumeric input device 917 (e.g., a keyboard), and a user interface (UI) navigation device 911 (e.g., a mouse). In one embodiment, the display, input device and cursor control device are a touch screen display. The computer system 900 may additionally include a storage device 916 (e.g., drive unit), a signal generation device 918 (e.g., a speaker), a network interface device 920, and one or more sensors 921, such as a global positioning system sensor, compass, accelerometer, or other sensor.

The drive unit 916 includes a machine-readable medium 922 on which is stored one or more sets of instructions and data structures (e.g., software 923) embodying or utilized by any one or more of the methodologies or functions described herein. The software 923 may also reside, completely or at least partially, within the main memory 901 and/or within the processor 902 during execution thereof by the computer system 900, the main memory 901 and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 923 may further be transmitted or received over a communications network 926 using a transmission medium via the network interface device 920 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

1. A system comprising:
a computer processor operable to:
calculate an overall talent scout score for each of a plurality of interviewers;
rank the plurality of interviewers as a function of the overall talent scout score for each of the plurality of interviewers;
display on a computer display device a representation of the overall talent scout scores for each of the plurality of interviewers;
calculate a participation score for each of the plurality of interviewers;
rank the plurality of interviewers as a function of the overall talent scout score for each of the plurality of interviewers and the participation score for each of the plurality of interviewers; and
display on a computer display device a representation of the overall talent scout scores and the participation scores for each of the plurality of interviewers;
wherein the computer processor is operable to calculate the overall talent scout score as follows:
calculate a module talent scout score for each interview module associated with a particular interviewer;
multiply each module talent scout score for the particular interviewer by an overall weighting factor to generate a plurality of weighted module talent scout scores for the particular interviewer; and
sum the plurality of weighted module talent scout scores for the particular interviewer;
wherein the overall weighting factor is a function of a number of interviews the particular interviewer has conducted for a first interview module and a number of interviews the particular interviewer has conducted for all other interview modules that are associated with the particular interviewer.

2. (canceled)

3. The system of claim 1, wherein the representation comprises a leader board, wherein the leader board comprises a two-dimensional grid, wherein the two dimensional grid comprises a plurality of compartments, wherein each compartment relates to a particular composite performance level, wherein interviewers having a high overall talent scout score and a high participation score are placed in a compartment in an upper-right portion of the grid, and wherein interviewers having a low overall talent scout score and a low participation score are placed in a lower-left portion of the grid.

4. (canceled)

5. (canceled)

6. The system of claim 1, wherein the computer processor is operable to:
calculate the module talent scout score for each of a plurality of interviewers associated with an interview module;
rank the plurality of interviewers associated with the interview module as a function of the module talent score for each interviewer and participation score for that interview module for each interviewer; and
display on the computer display device a representation of the module talent scout score and the participation score for one or more of the interviewers.

7. The system of claim 6, wherein the representation comprises a leader board, wherein the leader board comprises a two-dimensional grid, wherein the two dimensional grid comprises a plurality of compartments, wherein each compartment relates to a particular composite performance level, wherein interviewers having a high module talent scout score and a high participation score are placed in a compartment in an upper-right portion of the grid, and wherein interviewers having a low module talent scout score and a low participation score are placed in a lower-left portion of the grid.

8. The system of claim 1, wherein the computer processor is operable to calculate the module talent scout score as follows:
receive an interview talent scout score for the particular interviewer for a particular interview module;
multiply a current module talent scout score for the particular interviewer by a time discount factor, thereby generating a time-discounted module talent scout score; and
sum the interview talent scout score and the time-discounted module talent scout score.

9. The system of claim 8, wherein the computer processor is operable to:
calculate the interview talent scout score by summing a hiring outcome score and a rating difference score;
wherein the hiring outcome score is a function of an ability of the particular interviewer to predict a hiring outcome of a particular candidate; and
wherein the rating difference score is a comparison of a score for the particular candidate by the particular interviewer and scores for the particular candidate from other interviewers.

10. The system of claim 9, wherein the computer processor is operable to apply an interview weighting factor to the summing of the hiring outcome score and the rating difference score.

11. The system of claim 9, wherein the computer processor is operable to calculate the hiring outcome score as follows:
when a hiring recommendation by the particular interviewer regarding the particular candidate agrees with a hiring decision of a hiring committee or hiring manager regarding the particular candidate, subtracting a module importance value from a first base value; and
when the hiring recommendation by the particular interviewer regarding the particular candidate disagrees with the hiring decision of the hiring committee or hiring manager regarding the particular candidate, subtracting the module importance value from a second base value.

12. The system of claim 11, wherein the computer processor is operable to calculate the module importance value as follows:
determine a number of interviews using the particular interview module wherein a hiring recommendation of the interviewers using the particular interview module matches the hiring decision of the hiring committee or hiring manager for the particular interview module; and
dividing the number of interviews by a total number of interviews using the particular interview module.

13. The system of claim 9, wherein the computer processor is operable to calculate the rating difference score as follows:
determine a minimum of one of the following:
a difference between a rating of the particular candidate by the particular interviewer and an average of ratings of the particular candidate by other interviewers whose hiring recommendation match a hiring decision of a hiring committee or hiring manager;
a difference between a sum of the rating of the particular candidate by the particular interviewer and a module difficulty value, and an average of ratings of the particular candidate by other interviewers whose hiring recommendation match the hiring decision of the hiring committee or hiring manager; and
a first base value; and
subtracting the minimum from a second base value.

14. The system of claim 13, wherein the computer processor is operable to calculate the module difficulty value as follows:
determine a difference between an average score received by candidates for the particular interview module and an average score received by candidates for all other interview modules.

15. The system of claim 1, wherein the computer processor is operable to calculate the participation score as follows:
Participation Score=((I−mean(I))/std(I))*WF1)+((M−mean(M))/std(M))*WF2)+((Sk−mean(Sk))/std(Sk))*WF3)+((Sc−mean(Sc))/std(Sc))*WF4);
wherein I is a number of interviews “I” that an interviewer has conducted;
wherein M is a percentage of scheduled interviews that have been missed by the interviewer;
wherein Sk is a number of modules for which the interviewer is qualified as a master interviewer or an apprentice interviewer;
wherein Sc is the average of the ratings “Sc” given by a hiring committee or a hiring manager as a review of the feedback on a job candidate provided by the interviewer; and
wherein WF1, WF2, WF3, and WF4 are weighting factors.

16. The system of claim 1, wherein the computer processor is operable to normalize the overall talent scout scores for the plurality of individuals.

17. A non-transitory computer readable medium comprising instructions that when executed by a processor execute a process comprising:
calculating an overall talent scout score for each of a plurality of interviewers;
ranking the plurality of interviewers as a function of the overall talent scout score for each of the plurality of interviewers;
displaying on a computer display device a representation of the overall talent scout scores for each of the plurality of interviewers; and
calculating a participation score as follows:
Participation Score=((I−mean(I))/std(I))*WF1)+((M−mean(M))/std(M))*WF2)+((Sk−mean(Sk))/std(Sk))*WF3)+((Sc−mean(Sc))/std(Sc))*WF4);
wherein I is a number of interviews “I” that an interviewer has conducted;
wherein M is a percentage of scheduled interviews that have been missed by the interviewer;
wherein Sk is a number of modules for which the interviewer is qualified as a master interviewer or an apprentice interviewer;
wherein Sc is the average of the ratings “Sc” given by a hiring committee or a hiring manager as a review of feedback on a job candidate provided by the interviewer; and
wherein WF1, WF2, WF3, and WF4 are weighting factors.

18. The non-transitory computer readable medium of claim 17, comprising instructions for:
calculating a participation score for each of the plurality of interviewers;
ranking the plurality of interviewers as a function of the overall talent scout score for each of the plurality of interviewers and the participation score for each of the plurality of interviewers; and
displaying on a computer display device a representation of the overall talent scout scores and the participation scores for each of the plurality of interviewers.

19. The non-transitory computer readable medium of claim 18, wherein the representation comprises a leader board, wherein the leader board comprises a two-dimensional grid, wherein the two dimensional grid comprises a plurality of compartments, wherein each compartment relates to a particular composite performance level, wherein interviewers having a high overall talent scout score and a high participation score are placed in a compartment in an upper-right portion of the grid, and wherein interviewers having a low overall talent scout score and a low participation score are placed in a lower-left portion of the grid.

20. A method comprising:
calculating with a computer processor an overall talent scout score for each of a plurality of interviewers;
ranking with the computer processor the plurality of interviewers as a function of the overall talent scout score for each of the plurality of interviewers;
displaying on a computer display device a representation of the overall talent scout scores for each of the plurality of interviewers;
calculating a participation score for each of the plurality of interviewers;
ranking the plurality of interviewers as a function of the overall talent scout score for each of the plurality of interviewers and the participation score for each of the plurality of interviewers;
displaying on a computer display device a representation of the overall talent scout scores and the participation scores for each of the plurality of interviewers;
wherein the calculating the overall talent scout score comprises:
calculating a module talent scout score for each interview module associated with a particular interviewer;
multiplying each module talent scout score for the particular interviewer by an overall weighting factor to generate a plurality of weighted module talent scout scores for the particular interviewer; and
summing the plurality of weighted module talent scout scores for the particular interviewer;
wherein the overall weighting factor is a function of a number of interviews the particular interviewer has conducted for a first interview module and a number of interviews the particular interviewer has conducted for all other interview modules that are associated with the particular interviewer.

21. The method of claim 20, comprising:
wherein the representation comprises a leader board, wherein the leader board comprises a two-dimensional grid, wherein the two dimensional grid comprises a plurality of compartments, wherein each compartment relates to a particular composite performance level, wherein interviewers having a high overall talent scout score and a high participation score are placed in a compartment in an upper-right portion of the grid, and wherein interviewers having a low overall talent scout score and a low participation score are placed in a lower-left portion of the grid.
